(19) United States
(12) Patent Application Publication
(10) Pub. No.: US 2025/0285006 A1
(43) Pub. Date: Sep. 11, 2025

(54) SYSTEMS AND METHODS FOR CUSTOMIZING A MACHINE LEARNING MODEL

(71) Applicant: Capital One Services, LLC, McLean, VA (US)

(72) Inventors: Anirban DAS, McLean, VA (US); Milind NAPHADE, McLean, VA (US); Isha CHATURVEDI, Mountain View, CA (US); Nurtekin SAVAS, McLean, VA (US); Mohammad SOROWER, Great Falls, VA (US); Nima CHITSAZAN, Ridgefield, NJ (US); Qi YU, McLean, VA (US); Chenyang ZHU, McLean, VA (US); William HUANG, New York, NY (US)

(73) Assignee: Capital One Services, LLC, McLean, VA (US)

(21) Appl. No.: 18/597,577

(22) Filed: Mar. 6, 2024

(51) Int. Cl. G06N 20/00

(52) U.S. Cl. CPC G06N 20/00

(57) ABSTRACT

Systems and methods for customizing a machine learning model for responding to a user query. The system receives a user query from a user of a conversational program. The system determines a set of model requirements for a first machine learning model. Based on the set of model requirements, the system determines first supplemental data corresponding to the required input data and a formatting requirement corresponding to an activation pattern. The system performs pre-processing to obtain the first supplemental data from a first supporting software program and generates the first response using the first machine learning model.

### BACKGROUND

Current methods for using language models to generate conversational responses to user queries typically do not customize the activation or use of such language models to the particular needs of the user query. The shortcoming with this approach is that such language models are sometimes ill-suited to provide the accurate feedback most pertinent to a user's inquiry. For example, existing language models process all incoming queries using the same mechanism without regard for different requirements between types of requests. The result is that current methods for generating conversational responses with language models are not optimized for addressing complex user queries that may require consideration of data separate from the user query to better inform the response.

### SUMMARY

By contrast, the methods and systems disclosed herein use supplemental data and formatting requirements to provide additional context for a machine learning model to optimally consider a user's query and to modify the model's output for presentation to the user. This stands in contrast to conventional methods, which process all incoming user queries in the same manner. This conventional approach is particularly unsuitable for requests relying on outside data sources to supplement a user query, such as a request to update information relating to a user account. Conventional systems would not be able to inform the machine learning model with additional data necessary for a full response to the query, nor control the activation pattern of the machine learning model to obtain the most accurate result. Additionally, conventional systems do not edit the preliminary response by post-processing to optimize the contents or presentation of the response to protect confidentiality, maintain accuracy, and guarantee quality for responses to user queries. Conventional systems use a crude, one-size-fits-all approach to generating responses to user queries by processing queries using the same machine learning model in the same manner with no context from additional data.

In contrast, the system described herein can modify the activation pattern of a machine learning model based on the needs of a user query. Using the activation pattern, which describes the mechanisms by which the machine learning model generates outputs using inputs, the system may control algorithms and external programs used to bolster the generation of a preliminary response. The system may tailor the input to the machine learning model to include supplemental data suitable for the category of the user query and may use formatting requirements to enforce responses' adherence to compliance standards as well as quality standards.

In some aspects, methods and systems are described herein comprising: receiving a user query from a user of a conversational program, wherein the user query requires a first response; based on the user query, determining a set of model requirements for a first machine learning model, wherein the set of model requirements comprises required input data in generating the first response; based on the set of model requirements, determining first supplemental data corresponding to the required input data and a formatting requirement corresponding to an activation pattern, wherein the first supplemental data is necessitated by the user query to generate the first response; performing pre-processing to obtain the first supplemental data from a first supporting software program; and generating the first response using the first machine learning model for presentation to the user in the conversational program by processing the user query and the first supplemental data.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for supplementing and augmenting the activation of a machine learning model for responding to a user query, in accordance with one or more embodiments.

FIG. 2 shows an illustration of the steps involved in generating a response to a use query, in accordance with one or more embodiments.

FIG. 3 shows illustrative components for a system for supplementing and augmenting the activation of a machine learning model for responding to a user query, in accordance with one or more embodiments.

FIG. 4 shows a flowchart of the steps involved in supplementing and augmenting the activation of a machine learning model for responding to a user query, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

Systems and methods herein are used to adjust a machine learning model to better understand the context of a user query and thereby provide a more pertinent or comprehensive response. The system may receive a query through a conversational program from a user. The query may require a response that the system may generate using a first machine learning model. The system may determine a set of model requirements in association with the user query. The model requirements are intended to guide or describe input data or activation patterns of the machine learning model. In some embodiments, the model requirements additionally specify a formatting requirement regulating the output of the first machine learning model for presentation to the user. The system may determine and obtain first supplemental data to use as input in addition to the user query for a first machine learning model and use the first machine learning model to generate a preliminary response. The system may then post-process the preliminary response for adherence to the formatting requirement to generate the first response to the user query.

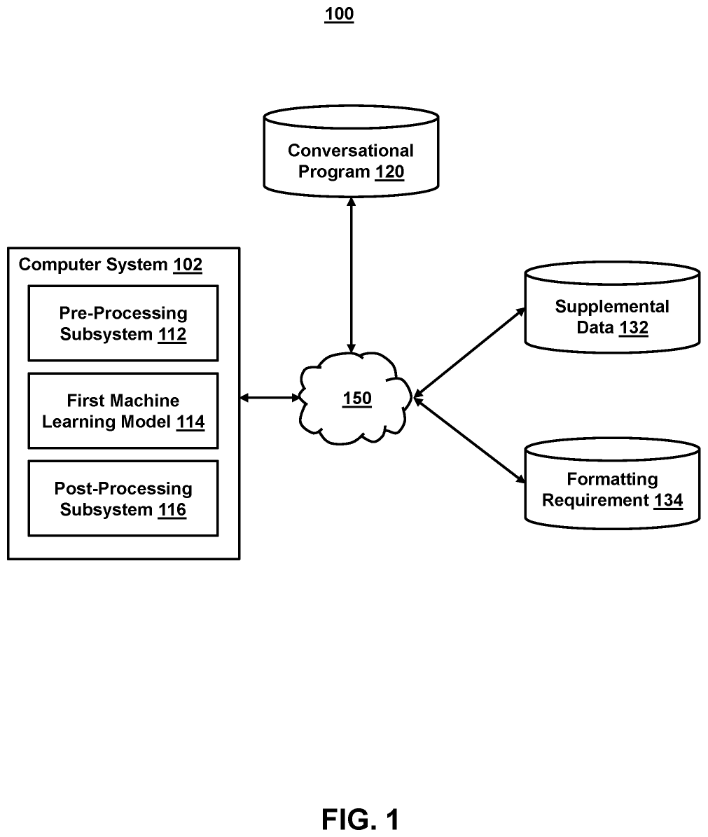

FIG. 1 shows an illustrative diagram for system 150 operating in Environment 100, which contains hardware and software components used to perform testing of software programs, in accordance with one or more embodiments. For example, Computer System 102, a part of system 150, may include Pre-Processing Subsystem 112, First Machine Learning Model 114, and Post-Processing Subsystem 116. Additionally, system 150 may create, store, or retrieve elements in Environment 100 such as Conversational Program 120, Supplemental Data 132, and/or Formatting Requirement 134.

The system may be used to generate responses to user queries in a conversational program (e.g., Conversational Program 120). For example, the system may be deployed in a conversational chat assistant service to receive user queries or inquiries regarding account states of user accounts. As referred to herein, a user query is a sentence, paragraph, or other block of text requesting a response with information or directing an action the user wants the system to perform. For example, a user query may indicate a lost password and require help logging in. In another example, a user query may request information on account actions available to them or have the system recommend a best course of action for managing their account. Some user queries may specify a course of action for the system, some may seek information, and some may request that the system generate a strategy to meet the user's needs. In some embodiments, the system may determine a category of the user query to be one of record retrieval, task execution, information update, and idea generation. The system will respond to a user query by replying to the user query in the conversational program. In some embodiments, the system may additionally or alternatively modify one or more aspects of a user's account state. For example, the system may update an address upon request, record a user preference for an aspect of the account, or change security settings for the account. The system may be expected to provide a first response in Conversational Program 120. The first response may be a text sequence like a sentence or short paragraph, conveying information to the user such as the answer to a question, a report of successful execution of a task, or a description of next steps.

The system (e.g., Pre-Processing Subsystem 112) may determine a set of model requirements for a first machine learning model (e.g., First Machine Learning Model 114). As referred to herein, pre-processing includes identifying supplemental data and formatting requirements. Additionally, the retrieval of the supplemental data may also be considered pre-processing. Supplemental data refers to data that may be used as input to a machine learning model that is not directly taken from the user query. For example, a machine learning model may access account information stored on a database to search for a user's login credentials. The account information in the database may be supplemental data used by the machine learning model in generating a response to the user query. A formatting requirement, as referred to herein, is a restriction on the presentation of responses to user queries. Restrictions may include requirements for the content of a response or the style of presentation for the response. For example, a formatting requirement may require the tone of a response to be suggestive and friendly rather than directive or dismissive. In another example, the formatting requirement may require the response to be free of identifying personal information out of privacy concerns for the user. In another example, the formatting requirement may adjust the confidence level of a response in order to avoid over-promising when executing a task. Formatting requirements may be used to inform the pre-processing or post-processing of the machine learning model before or after generating a preliminary response.

To identify the supplemental data and formatting requirement, in some embodiments, the system may sort the user query into a category, which can be one of record retrieval, task execution, information update, and idea generation. Based on the category of the user query, Pre-Processing Subsystem 112 may determine an activation pattern of the first machine learning model. As referred to herein, an activation pattern (also referred to as a prompting pattern) describes the manner in which a machine learning model transforms its input values into an output. For example, an activation pattern may describe an algorithm used by the machine learning model to generate a text sequence in response to input values. In another example, prompting patterns for a language processing model may describe roles the model may perform in relation to a user's query. Prompting patterns may include persona pattern, audience persona pattern, cognitive verifier pattern, and meta language creation pattern. In another example, an activation pattern may describe the parameters, weights, biases, and loss functions of a machine learning model used in computation. In some embodiments, the system may choose activation patterns from pre-set standard activation patterns. For example, the algorithm for a machine learning model may be chosen from standard options corresponding to categories of incoming user requests. An activation pattern may also describe additional software programs used to aid a machine learning model. For example, a machine learning model may use a generative program to classify its inputs before the model does further processing to generate an output. In another example, an activation pattern may use a program to process its output into a format suitable for a preliminary response. For example, the machine learning model may generate an output indicating a piece of advice in a real-valued format. The system may wish to present the preliminary response in a text format, and may thus use an embedding program to translate the real-valued output of the machine learning model into the preliminary response.

The system may also generate an activation pattern based on the user query and/or the category which the user query falls into. For example, the system may select an algorithm for First Machine Learning Model 114 based on the category of the user query. In some embodiments, the system may use an interpretation machine learning model to determine a category for a user query. For example, the system may choose a language processing algorithm like a transformer algorithm to provide textual responses to a query in response to categorizing the query as an information-seeking type. The transformer algorithm may be trained to imitate natural language conversations, for example providing encyclopedic knowledge of matters on a certain topic to users who perform research on the topic. In this example, the activation pattern may specify the transformer algorithm for First Machine Learning Model 114 and control its weights and biases to produce natural language outputs.

For other categories of user queries, the system may choose a different algorithm or program for a response to the user query. For example, if a user query entails the execution of a payment, the system may direct the contents of the user query to a payment-processing system. The system may use First Machine Learning Model 114 to transform the text of the user query into a real-valued vector of a specific format. The format may be designed for use by the payment-processing system and may contain a payment amount, an intended date of execution, and a recipient address. The payment-processing system may then execute the payment, and transmit a message indicating success back to the system. The system may then use the message to generate a preliminary response. In this example, the activation pattern may specify an algorithm for First Machine Learning Model 114 to be a classification algorithm that detects portions of the user query and extracts the relevant information for the real-valued vector to transmit to the payment-processing system. The activation pattern may also specify its use in combination with the payment-processing system to execute the payment request and receive an indication of completion. In another example, the user query may seek login credentials for an account. The system may use a software program to access a database with account login credentials. The activation pattern may specify one such software program designed to provide a level of access enough to retrieve the login credentials. Additionally, the activation pattern may specify how much information can be transmitted back to the user and how much information is to remain private and confidential. For example, the activation pattern may require that the system provide encrypted or blurred versions of passwords to the user, or provide a recovery address instead of showing the login credentials in plain text form.

Based on the category of the user query, the user query, and the history of the conversational program, Pre-Processing Subsystem 112 may determine a type of relevant data and a set of external programs. The relevant data may be data required to execute the type of request that the user query falls into. For example, if the user wishes to update account information, the system may need to retrieve current account information. In another example, if the user wants to retrieve a lost password, the system may need information on login authentication credentials associated with the account. The system may determine the type of relevant data using a deterministic program in some embodiments. Each category of user query may correspond to a specific piece of information, and the system may thus retrieve the required information from a known data source. For example, the system may transmit a request to the user login database upon determining that the user wants to learn about their login information. The system may generate the set of model requirements to include the activation pattern, the type of relevant data, and the set of external programs.

The system may obtain the first supplemental data (e.g., Supplemental Data 132). The system may generate a plurality of candidate datasets using external programs, such as data sources like user account databases. The external programs from which the system may derive candidate datasets may include designated sources for particular types of user queries. For example, for queries asking for travel advice, the system may refer to a travel database for all queries of this nature. Similarly, for queries requesting to review account usage history, the system may refer to a central database recording usage data for all accounts. The system may alternatively or additionally execute one or more software programs to receive a response. For example, the system may communicate with an API designed to handle account updates to receive information on whether the account update was successfully completed, or whether there were any errors resulting from the account update. The response from the API may be used as a candidate dataset. In some embodiments, the system may find candidate datasets from more than one data source for a user query. The system may, for example, find an abbreviated user account history from one source, and a comprehensive account history from a different source. The system may generate a ranking of the candidate datasets based on relevance metrics indicating the likely relatedness from a candidate dataset to the user query. For example, data sources used more commonly for similar user queries in the past may receive higher numbers for relevance metrics. Based on the ranking of the plurality of candidate datasets, the system may thus choose Supplemental Data to be the most relevant dataset.

The system may generate a preliminary response using the first machine learning model (e.g., First Machine Learning Model 114). The system may cause the first machine learning model to process the user query and the first supplemental data as input. First Machine Learning Model 114 may be a language processing model using a deep neural network algorithm or a transformer-based algorithm. First Machine Learning Model 114 may be trained on training data consisting of past user queries and supplemental data, formatting requirements, and responses corresponding to each past user query. The training data may be used as a fine-tuning and reinforcement learning training process which incentivizes First Machine Learning Model 114 to produce responses to user queries using supplemental data as well the text of the user queries. The fine-tuning and reinforcement learning training process may use a loss function to enforce adherence to the formatting requirement and/or similarity to past exemplary responses. The fine-tuning and reinforcement learning process causes updates to parameters, weights, and biases of First Machine Learning Model 114 to produce output more coherent and satisfactory in view of the training data. Using recurrent layers, feedforward layers, embedding layers, and attention layers, First Machine Learning Model 114 may generate an output text sequence. In some embodiments, the output of First Machine Learning Model 114 may be presented to the user in Conversational Program 120 as the response to the user query. In some other embodiments, the output of First Machine Learning Model 114 may be used as a preliminary response which requires post-processing to generate a response for presentation to the user. The preliminary response comprises textual data with associated metadata, where the textual data contains information responsive to the user query, and where the associated metadata limits presenting the textual data to the user in the conversational program. For example, the metadata may specify a portion of the preliminary response that most succinctly summarizes the answer to the user's request. Alternatively or additionally, the metadata may specify the grammar or tone of the response, among other aspects of the response to the query.

The system may perform post-processing of the preliminary response using a second supporting software program (e.g., Post-Processing Subsystem 116). As referred to herein, post-processing is editing the preliminary response in terms of content or presentation to meet requirements. The system may identify a set of discrepancies based on the formatting requirement and the preliminary response. a discrepancy may be, for example, confidential user login information being contained in the response. Such a response would violate confidentiality requirements that may be contained in Formatting Requirement 134. In another example, the preliminary response may be too long for a formatting requirement, and Post-Processing Subsystem 116 may need to remove parts of the preliminary response before presenting to the user. Accordingly, the system may generate a set of corrections by, identifying a correction corresponding to each discrepancy. The set of corrections modifies the textual data or the associated metadata of the preliminary response. For example, the system may apply a change of tone to the preliminary response. In another example, the system may remove certain pieces of confidential information from the preliminary response to align with a privacy requirement. In another example, the system may select to not display the preliminary response at all, instead using a boilerplate response for the category of the user query due to uncorrectable deviations from formatting requirements of the preliminary response. If the preliminary response needs corrections, the system may apply the set of corrections to the preliminary response to generate the first response. The system may then present the first response to the user based on the post-processing of the preliminary response.

In some embodiments, the system may receive additional instructions from the user after the user receives the first response. For example, the user may see the first response in the conversational program and decide to make a follow-up request. For example, the user may request a second response, where the second response may be intended to further explain information presented in the first response. Alternatively or additionally, the second response may execute a task that may be related to the initial user query. The user request for the second response limits the content or format of the second response. For example, the user request may specifically require the account information of a newly opened account. In another example, the user request may specify a follow-up change to their account status after an initial requested change outlined in the first query. The system may generate an updated formatting requirement by updating the formatting requirement based on the user request. For example, the system may cause the formatting requirement to reflect the user request by adding requirements limiting the content or presentation. For example, the system uses a requirement to eliminate redundancies with the first response.

For example, the user may submit a first query describing a desired first change to their account state. The system performs the change and responds with a first response indicating successful completion. The user may then submit a follow-up request, describing a desired second change to their account state. The system may generate a formatting requirement for a second response, where the formatting requirement limits the second response to only describe the successful completion of the second change and not the first change. In another example, the system may generate formatting requirements specifying required input data, which may be distinct from the first supplemental data used in generating the first response. For example, the supplemental data may be a read-privilege data package used to locate the user information responsive to the user query and generate a first response. The user may make a request to change one or more pieces of user information. The system may need a modification privilege data package to change user information, and the first supplemental data is no longer enough. The system may determine second supplemental data based on the user request. The second supplemental data may be used as additional input to the first machine learning model, analogous to the first supplemental data. The system may generate a preliminary response using the first machine learning model by processing the user query and the second supplemental data. For example, the system may use the supplemental data to locate information relevant to the user query and provide a more comprehensive preliminary response. The system may perform post-processing of the preliminary response to modify the preliminary response to adhere to the updated formatting requirement, in a similar to adjusting the preliminary response for formatting requirements of the first response as described above. Based on the post-processing of the preliminary response, the system may generate the second response for presentation to the user in the conversational program.

The following is an example of the system engaging in conversation with a user. The system receives a user query, such as an information retrieval query including the question “What is Zelle”. The system consequently uses an orchestrator program to interface with multiple components with the system to generate a response. The orchestrator program may first apply pre-processing guardrails to the user query to make sure the user query has appropriate content within the bounds of actions permitted by the conversational program. The pre-processing guardrails may also encode the user query to text tokens or real-valued embeddings for further use by other components of the system. The orchestrator program may additionally retrieve a chat history from the computer system's memory. The orchestrator program may provide the user query and the chat history to a task planner program. The task planner program may include a language processing model designed to produce an execution of steps including the retrieval and processing of data, the generation of a preliminary response, and the post-processing of the preliminary response using one or more other software programs. The task planner determines a series of steps involving other programs to provide the information for the user query. In this example, the task planner may return a token or real-valued embedding corresponding to the search action to indicate that the appropriate action is to select a search program from an experience store to retrieve information. An experience store refers to a collection of programs, data, and predetermined logic useful in informing a response to a user query. For example, the experience store may be used to interface with user login databases to verify an identity, to complete a transaction, or to find information relating to the Zelle transfer network. Based on the task planner program's output, the orchestrator program selects modules from the experience store. In this example, it may be a Semantic Information Retrieval module to answer the user's informational query. The orchestrator program may additionally cause a unified modular natural language processing module to activate through a question-answer prompt, causing the module to use a language processing machine learning model to provide a textual response to its input. The orchestrator program then uses the task planner to determine appropriate post-processing of this response. The post-processing may include guardrail programs or logic to ensure the factual accuracy of the response and its confidentiality and compliance with formatting requirements. The orchestrator may then transmit the post-processed response back to the conversational program to answer the user query.

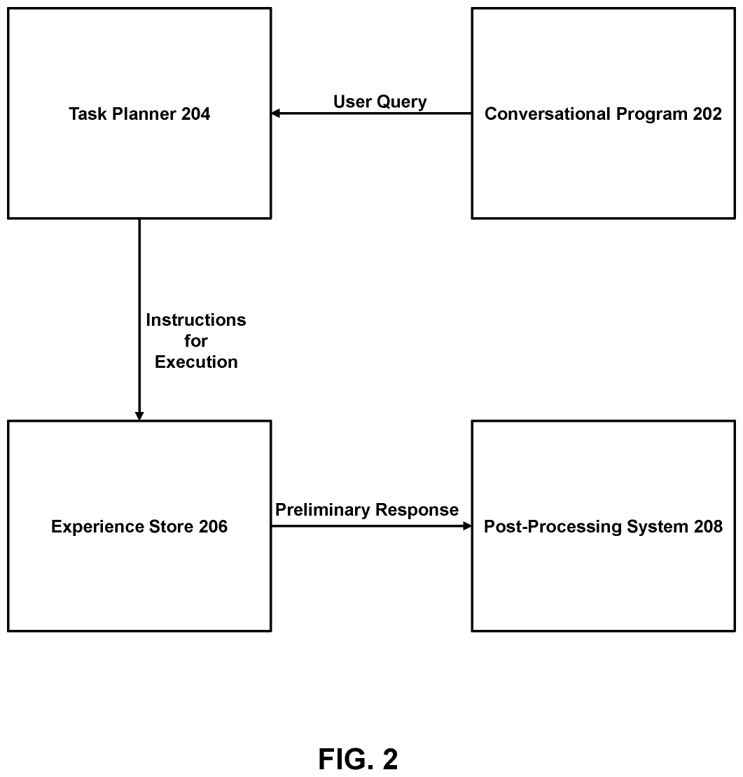

FIG. 2 shows various components of the system used to provide context for a machine learning model in generating a response to a user query. The process begins when Conversational Program 202 receives a user query and transmits it to Task Planner 204. For example, the system may be deployed in a conversational chat assistant service to receive user queries or inquiries regarding account states of user accounts. For example, a user query may indicate a lost password and require help logging in. In another example, a user query may request information on account actions available to them or have the system recommend a best course of action for managing their account. Some user queries may specify a course of action for the system, some may seek information, and some may request that the system generate a strategy to meet the user's needs. In some embodiments, the system may determine a category of the user query to be one of record retrieval, task execution, information update, and idea generation.

Task Planner 204 may take the user query as an input and process it to determine a category for the user query. Task Planner 204 may be a software program using a deterministic logic, or a machine learning model trained to perform classification. For example, Task Planner 204 may include a language-processing machine learning model trained to classify a user query into a category. The machine learning model may be trained on training data consisting of past user queries with corresponding correct classifications. The training data may be used as a fine-tuning and reinforcement learning training process which incentivizes the machine learning model to produce categories based on the text of the user queries. The fine-tuning and reinforcement learning training process may use a loss function to enforce adherence to the correct category. The fine-tuning and reinforcement learning process causes updates to parameters, weights and biases of the machine learning model to produce output more coherent and satisfactory in view of the training data. Using recurrent layers, feedforward layers, embedding layers, and attention layers, the machine learning model may sort a user query into a category, for example record retrieval, task execution, information update, or idea generation. Using the category determined by Task Planner 204, Experience Store 206 may then identify supplemental data and formatting requirement.

In some embodiments, Task Planner 204 may select activation patterns and/or necessary pre-processing for a language processing unit. Based on the category of the user query, Task Planner 204 may determine an activation pattern of the first machine learning model. The activation pattern may include a formatting requirement. For example, the system may select an algorithm for First Machine Learning Model 114 based on the category of the user query. In some embodiments, the system may use an interpretation machine learning model to determine a category for a user query. For example, the system may choose a language processing algorithm like a transformer algorithm to provide textual responses to a query in response to categorizing the query as an information-seeking type. The transformer algorithm may be trained to imitate natural language conversations, for example providing encyclopedic knowledge of matters on a certain topic to users who perform research on the topic. In this example, the activation pattern may specify the transformer algorithm for First Machine Learning Model 114 and control its weights and biases to produce natural language outputs. For other categories of user queries, the system may choose a different algorithm or program for a response to the user query.

Based on the category of the user query, the user query, and a history of the conversational program, Experience Store 206 may determine a type of relevant data and a set of external programs. The relevant data may be data required to execute the type of request that the user query falls into. For example, if the user wishes to update account information, the system may need to retrieve current account information. In another example, if the user wants to retrieve a lost password, the system may need information on login authentication credentials associated with the account. Experience Store 206 may determine the type of relevant data using a deterministic program in some embodiments. Each category of user query may correspond to a specific piece of information, and the system may thus retrieve the required information from a known data source. For example, the system may transmit a request to the user login database upon determining that the user wants to learn about their login information. The system may generate the set of model requirements to include the activation pattern, the type of relevant data, and the set of external programs.

The system may generate a preliminary response using the first machine learning model. The system may cause the first machine learning model to process the user query and the first supplemental data as input. The machine learning model may generate an output text sequence. In some embodiments, the output of the machine learning model may be presented to the user as the response to the user query. In some other embodiments, the output of the machine learning model may be used as a preliminary response which requires post-processing to generate a response for presentation to the user. The preliminary response comprises textual data with associated metadata, where the textual data contains information responsive to the user query, and where the associated metadata limits presenting the textual data to the user in the conversational program. For example, the metadata may specify a portion of the preliminary response that most succinctly summarizes the answer to the user's request. Alternatively or additionally, the metadata may specify the grammar or tone of the response, among other aspects of the response to the query.

Post-Processing System 208 may take the preliminary response as input and generate a first response as output. Post-Processing System 208 may edit the preliminary response in terms of content or presentation to meet requirements. Post-Processing System 208 may identify a set of discrepancies based on the formatting requirement and the preliminary response. a discrepancy may be, for example, confidential user login information being contained in the response. Such a response would violate confidentiality requirements that may be contained in Formatting Requirement 134. In another example, the preliminary response may be too long for a formatting requirement, and Post-Processing System 208 may need to remove parts of the preliminary response before presenting to the user. Accordingly, the system may generate a set of corrections by, identifying a correction corresponding to each discrepancy. The set of corrections modifies the textual data or the associated metadata of the preliminary response. For example, the system may apply a change of tone to the preliminary response. In another example, Post-Processing System 208 may remove certain pieces of confidential information from the preliminary response to align with a privacy requirement. In another example, the system may select to not display the preliminary response at all, instead using a boilerplate response for the category of the user query due to uncorrectable deviations from formatting requirements of the preliminary response. If the preliminary response needs corrections, Post-Processing System 208 may apply the set of corrections to the preliminary response to generate the first response. Post-Processing System 208 may then present the first response to the user based on the post-processing of the preliminary response.

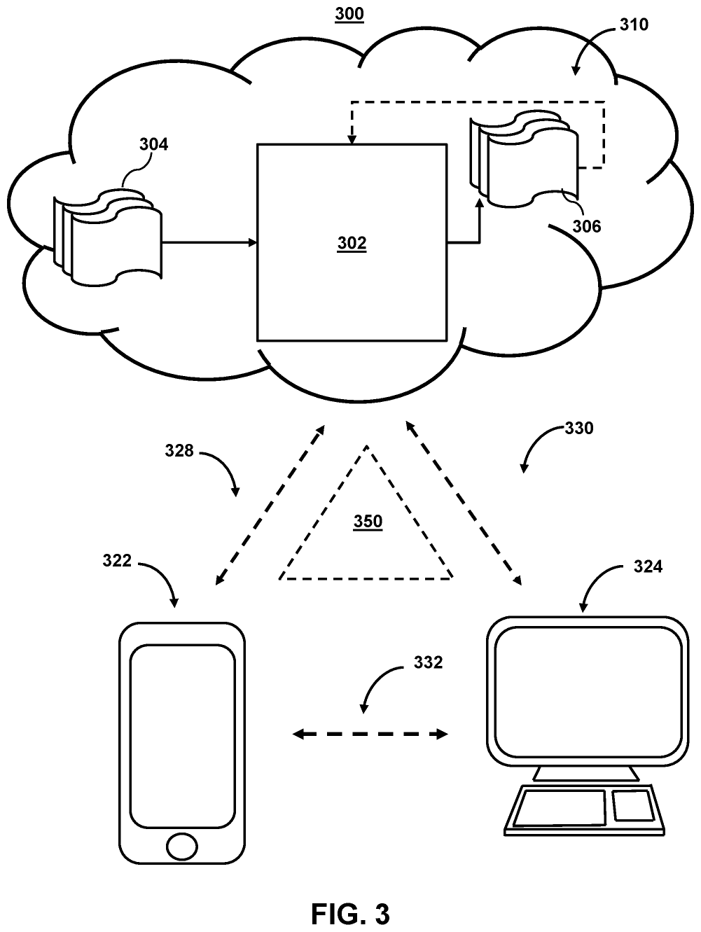

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., the conversational program allowing a user to submit queries and receive responses).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the Machine learning model to classify the first labeled feature input with the known prediction (e.g., labeling a received user query into one of many types).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The output of the model (e.g., model 302) may be used to generate test cases from figuration files, for example.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

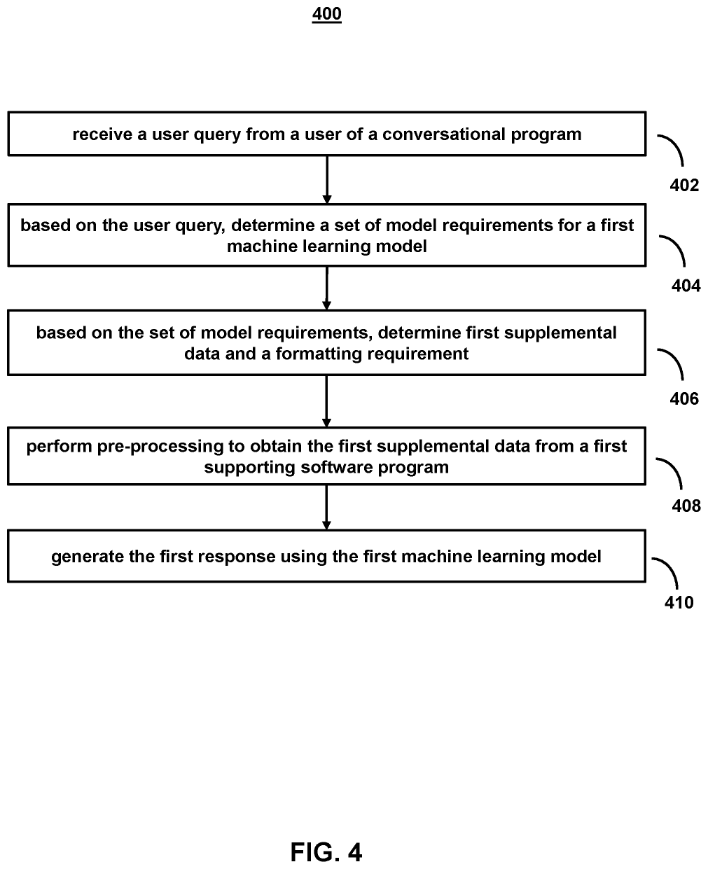

FIG. 4 shows a flowchart of the steps involved in customizing a machine learning model for generating responses to user queries, in accordance with one or more embodiments. For example, the system may use process 400 (e.g., as implemented on one or more system components described above) in order to receive user queries, generate supplemental data and formatting requirements based on the user query, generating a preliminary response using a machine learning model, and post-processing the response to reply to the user query.

At step 402, process 400 (e.g., using one or more components described above) receives a user query from a user of a conversational program. For example, the system may be deployed in a conversational chat assistant service to receive user queries or inquiries regarding account states of user accounts. A user query may be a sentence, paragraph or other block of text requesting a response with information or directing an action the user wants the system to perform. For example, a user query may indicate a lost password and require help logging in. In another example, a user query may request information on account actions available to them or have the system recommend a best course of action for managing their account. Some user queries may specify a course of action for the system, some may seek information, and some may request that the system generate a strategy to meet the user's needs. In some embodiments, the system may determine a category of the user query to be one of record retrieval, task execution, information update, and idea generation. The system will respond to a user query by replying to the user query in the conversational program. In some embodiments, the system may additionally or alternatively modify one or more aspects of a user's account state. For example, the system may update an address upon request, record a user preference for an aspect of the account, or change security settings for the account. The system may be expected to provide a first response in Conversational Program 120. The first response may be a text sequence like a sentence or short paragraph, conveying information to the user such as the answer to a question, a report of successful execution of a task, or a description of next steps.

At step 404, process 400 (e.g., using one or more components described above) determines a set of model requirements for a first machine learning model. The system (e.g., Pre-Processing Subsystem 112) may determine a set of model requirements for a first machine learning model (e.g., First Machine Learning Model 114). Pre-processing may include identifying supplemental data and formatting requirements. Additionally, the retrieval of the supplemental data may also be considered pre-processing. Supplemental data refers to data that may be used as input to a machine learning model that is not directly taken from the user query. For example, a machine learning model may access account information stored on a database to search for a user's login credentials. The account information in the database may be supplemental data used by the machine learning model in generating a response to the user query. A formatting requirement may restrict the presentation of responses to user queries. Restrictions may include requirements for the content of a response or the style of presentation for the response. For example, a formatting requirement may require the tone of a response to be suggestive and friendly rather than directive or dismissive. In another example, the formatting requirement may require the response to be free of identifying personal information out of privacy concerns for the user. In another example, the formatting requirement may adjust the confidence level of a response in order to avoid over-promising when executing a task. Formatting requirements may be used to inform the pre-processing or post-processing of the machine learning model before or after generating a preliminary response.

At step 406, process 400 (e.g., using one or more components described above) determines first supplemental data and a formatting requirement. To identify the supplemental data and formatting requirement, in some embodiments, the system may sort the user query into a category, which can be one of record retrieval, task execution, information update, and idea generation. Based on the category of the user query, Pre-Processing Subsystem 112 may determine an activation pattern of the first machine learning model. An activation pattern relates to how a machine learning model transforms its input values into an output. For example, an activation pattern may describe an algorithm used by the machine learning model to generate a text sequence in response to input values. In another example, an activation pattern may describe the parameters, weights, biases, and loss functions of a machine learning model used in computation. In some embodiments, the system may choose activation patterns from pre-set standard activation patterns. For example, the algorithm for a machine learning model may be chosen from standard options corresponding to categories of incoming user requests. An activation pattern may also describe additional software programs used to aid a machine learning model. For example, a machine learning model may use a clustering program to classify its inputs before the model does further processing to generate an output. In another example, an activation pattern may use a program to process its output into a format suitable for a preliminary response. For example, the machine learning model may generate an output indicating a piece of advice in a real-valued format. The system may wish to present the preliminary response in a text format, and may thus use an embedding program to translate the real-valued output of the machine learning model into the preliminary response.

The system may also generate an activation pattern based on the user query and/or the category which the user query falls into. For example, the system may select an algorithm for First Machine Learning Model 114 based on the category of the user query. In some embodiments, the system may use an interpretation machine learning model to determine a category for a user query. For example, the system may choose a language processing algorithm like a transformer algorithm to provide textual responses to a query in response to categorizing the query as an information-seeking type. The transformer algorithm may be trained to imitate natural language conversations, for example providing encyclopedic knowledge of matters on a certain topic to users who perform research on the topic. In this example, the activation pattern may specify the transformer algorithm for First Machine Learning Model 114 and control its weights and biases to produce natural language outputs.

For other categories of user queries, the system may choose a different algorithm or program for a response to the user query. For example, if a user query entails the execution of a payment, the system may direct the contents of the user query to a payment-processing system. The system may use First Machine Learning Model 114 to transform the text of the user query into a real-valued vector of a specific format. The format may be designed for use by the payment-processing system and may contain a payment amount, an intended date of execution, and a recipient address. The payment-processing system may then execute the payment, and transmit a message indicating success back to the system. The system may then use the message to generate a preliminary response. In this example, the activation pattern may specify an algorithm for First Machine Learning Model 114 to be a classification algorithm that detects portions of the user query and extracts the relevant information for the real-valued vector to transmit to the payment-processing system. The activation pattern may also specify its use in combination with the payment-processing system to execute the payment request and receive an indication of completion. In another example, the user query may seek login credentials for an account. The system may use a software program to access a database with account login credentials. The activation pattern may specify one such software program designed to provide a level of access enough to retrieve the login credentials. Additionally, the activation pattern may specify how much information can be transmitted back to the user and how much information is to remain private and confidential. For example, the activation pattern may require that the system provide encrypted or blurred versions of passwords to the user, or provide a recovery address instead of showing the login credentials in plain text form.

At step 408, process 400 (e.g., using one or more components described above) performs pre-processing to obtain the first supplemental data. Based on the category of the user query, the user query, and a history of the conversational program, Pre-Processing Subsystem 112 may determine a type of relevant data and a set of external programs. The relevant data may be data required to execute the type of request that the user query falls into. For example, if the user wishes to update account information, the system may need to retrieve current account information. In another example, if the user wants to retrieve a lost password, the system may need information on login authentication credentials associated with the account. The system may determine the type of relevant data using a deterministic program in some embodiments. Each category of user query may correspond to a specific piece of information, and the system may thus retrieve the required information from a known data source. For example, the system may transmit a request to the user login database upon determining that the user wants to learn about their login information. The system may generate the set of model requirements to include the activation pattern, the type of relevant data, and the set of external programs.

The system may obtain the first supplemental data (e.g., Supplemental Data 132). The system may generate a plurality of candidate datasets using external programs, such as data sources like user account databases. The external programs from which the system may derive candidate datasets may include designated sources for particular types of user queries. For example, for queries asking for travel advice, the system may refer to a travel database for all queries of this nature. Similarly, for queries requesting to review account usage history, the system may refer to a central database recording usage data for all accounts. The system may alternatively or additionally execute one or more software programs to receive a response. For example, the system may communicate with an API designed to handle account updates to receive information on whether the account update was successfully completed, or whether there were any errors resulting from the account update. The response from the API may be used as a candidate dataset. In some embodiments, the system may find candidate datasets from more than one data source for a user query. The system may, for example, find an abbreviated user account history from one source, and a comprehensive account history from a different source. The system may generate a ranking of the candidate datasets based on relevance metrics indicating the likely relatedness from a candidate dataset to the user query. For example, data sources used more commonly for similar user queries in the past may receive higher numbers for relevance metrics. Based on the ranking of the plurality of candidate datasets, the system may thus choose Supplemental Data to be the most relevant dataset.

At step 410, process 400 (e.g., using one or more components described above) generates the first response using the first machine learning model. The system may generate a preliminary response using the first machine learning model (e.g., First Machine Learning Model 114). The system may cause the first machine learning model to process the user query and the first supplemental data as input. First Machine Learning Model 114 may be a language processing model using a deep neural network algorithm or a transformer-based algorithm. First Machine Learning Model 114 may be trained on training data consisting of past user queries and supplemental data, formatting requirements, and responses corresponding to each past user query. The training data may be used as a fine-tuning and reinforcement learning training process which incentivizes First Machine Learning Model 114 to produce responses to user queries using supplemental data as well the text of the user queries. The fine-tuning and reinforcement learning training process may use a loss function to enforce adherence to the formatting requirement and/or similarity to past exemplary responses. The fine-tuning and reinforcement learning process causes updates to parameters, weights and biases of First Machine Learning Model 114 to produce output more coherent and satisfactory in view of the training data. Using recurrent layers, feedforward layers, embedding layers, and attention layers, First Machine Learning Model 114 may generate an output text sequence. In some embodiments, the output of First Machine Learning Model 114 may be presented to the user in Conversational Program 120 as the response to the user query. In some other embodiments, the output of First Machine Learning Model 114 may be used as a preliminary response which requires post-processing to generate a response for presentation to the user. The preliminary response comprises textual data with associated metadata, where the textual data contains information responsive to the user query, and where the associated metadata limits presenting the textual data to the user in the conversational program. For example, the metadata may specify a portion of the preliminary response that most succinctly summarizes the answer to the user's request. Alternatively or additionally, the metadata may specify the grammar or tone of the response, among other aspects of the response to the query.

The system may perform post-processing of the preliminary response using a second supporting software program (e.g., Post-Processing Subsystem 116). Post-processing may include editing the preliminary response in terms of content or presentation to meet requirements. The system may identify a set of discrepancies based on the formatting requirement and the preliminary response. a discrepancy may be, for example, confidential user login information being contained in the response. Such a response would violate confidentiality requirements that may be contained in Formatting Requirement 134. In another example, the preliminary response may be too long for a formatting requirement, and Post-Processing Subsystem 116 may need to remove parts of the preliminary response before presenting to the user. Accordingly, the system may generate a set of corrections by, identifying a correction corresponding to each discrepancy. The set of corrections modifies the textual data or the associated metadata of the preliminary response. For example, the system may apply a change of tone to the preliminary response. In another example, the system may remove certain pieces of confidential information from the preliminary response to align with a privacy requirement. In another example, the system may select to not display the preliminary response at all, instead using a boilerplate response for the category of the user query due to uncorrectable deviations from formatting requirements of the preliminary response. If the preliminary response needs corrections, the system may apply the set of corrections to the preliminary response to generate the first response. The system may then present the first response to the user based on the post-processing of the preliminary response.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

The present techniques will be better understood with reference to the following enumerated embodiments:

1. A method comprising: receiving a user query from a user of a conversational program, wherein the user query requires a first response; based on the user query, determining a set of model requirements for a first machine learning model, wherein the set of model requirements comprises required input data or activation patterns of the first machine learning model in generating the first response; based on the set of model requirements, determining first supplemental data corresponding to the required user input and a formatting requirement corresponding to the output patterns, wherein the first supplemental data is necessitated by the user query to generate the first response, and wherein the formatting requirement specifies modifications for the first response to satisfy one or more requirements relating to content or presentation; performing pre-processing to obtain the first supplemental data from a first supporting software program; generating a preliminary response using the first machine learning model by processing the user query and the first supplemental data; performing post-processing of the preliminary response using a second supporting software program, wherein the second supporting software program is designed to modify the preliminary response to adhere to the formatting requirement; and based on the post-processing of the preliminary response, generating the first response for presentation to the user in the conversational program.
2. A method comprising: receiving a user query from a user of a conversational program, wherein the user query requires a first response; based on the user query, determining a set of model requirements for a first machine learning model, wherein the set of model requirements comprises required input data in generating the first response; based on the set of model requirements, determining first supplemental data corresponding to the required input data and a formatting requirement corresponding to an activation pattern, wherein the first supplemental data is necessitated by the user query to generate the first response; performing pre-processing to obtain the first supplemental data from a first supporting software program; and generating the first response using the first machine learning model for presentation to the user in the conversational program by processing the user query and the first supplemental data.
3. The method of any one of the preceding embodiments, further comprising: generating a preliminary response using the first machine learning model by processing the user query and the first supplemental data; performing post-processing of the preliminary response using a second supporting software program, wherein the second supporting software program is designed to modify the preliminary response to adhere to the formatting requirement; and based on the post-processing of the preliminary response, generating the first response for presentation to the user in the conversational program.
4. The method of any one of the preceding embodiments, wherein the preliminary response comprises textual data with associated metadata, wherein the textual data contains information responsive to the user query, and wherein the associated metadata limits presenting the textual data to the user in the conversational program.
5. The method of any one of the preceding embodiments, wherein the post-processing of the preliminary response comprises: using the second supporting software program, identifying a set of discrepancies based on the formatting requirement, and the preliminary response, wherein the set of discrepancies comprises one or more aspects of the preliminary response that fail to meet the formatting requirement; generating a set of corrections by, for each discrepancy in the set of discrepancies, identifying a correction corresponding to the discrepancy, wherein the set of corrections comprises modifications to the textual data or the associated metadata of the preliminary response; and applying the set of corrections to the preliminary response to generate the first response.
6. The method of any one of the preceding embodiments, wherein determining the set of model requirements comprises: determining a category of the user query, wherein the category is one of record retrieval, task execution, information update, and idea generation; based on the category of the user query, determining an activation pattern of the first machine learning model; based on the category of the user query, the user query, and a history of the conversational program, determining a type of relevant data and a set of external programs; and generating the set of model requirements to include the activation pattern, the type of relevant data, and the set of external programs.
7. The method of any one of the preceding embodiments, wherein the first supplemental data comprises data from the type of relevant data, wherein the set of external programs is used to obtain the first supplemental data.
8. The method of any one of the preceding embodiments, wherein determining the first supplemental data comprises: generating a plurality of candidate datasets using the set of external programs, wherein the plurality of candidate datasets contain data related to the user query; generating a ranking of the plurality of candidate datasets based on relevance metrics for each candidate dataset in the plurality of candidate datasets, wherein the relevance metrics indicate a likely relatedness from a candidate dataset to the user query; and based on the ranking of the plurality of candidate datasets, generating the first supplemental data based on one or more of the plurality of candidate datasets.
9. The method of any one of the preceding embodiments, wherein determining the formatting requirement comprises: retrieving a set of compliance requirements and a set of quality requirements, wherein the set of compliance requirements restricts the first response to maintain cybersecurity and confidentiality, and wherein the set of quality requirements restricts the first response for factual accuracy and relevance; and generating the formatting requirement based on the set of compliance requirements and the set of quality requirements.
10. The method of any one of the preceding embodiments, further comprising: receiving training data comprising past user queries and supplemental data, formatting requirements, and responses corresponding to each past user query; and training the first machine learning model on the training data, wherein the first machine learning model uses a deep neural network to generate conversational responses to input user queries.
11. The method of any one of the preceding embodiments, wherein processing the user query and the first supplemental data comprises: causing the first machine learning model to process the user query and the first supplemental data as input; and using recurrent layers, feedforward layers, embedding layers, and attention layers of the first machine learning model, generating an output text sequence corresponding to the first response.
12. The method of claim 2, further comprising: receiving, in associate with the user query, a user request defining a second response, wherein the user request limits the content or format of the second response; generating an updated formatting requirement by updating the formatting requirement based on the user request; and determining second supplemental data based on the user request.
13. The method of any one of the preceding embodiments, further comprising: generating a preliminary response using the first machine learning model by processing the user query and the second supplemental data; performing post-processing of the preliminary response to modify the preliminary response to adhere to the updated formatting requirement; and based on the post-processing of the preliminary response, generating the second response for presentation to the user in the conversational program.
14. One or more tangible, non-transitory, computer-readable media storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-13.

What is claimed is:

1. A system for dynamically adjusting a machine learning model for producing responses to queries, comprising:
one or more processors; and
one or more non-transitory, computer-readable media comprising instructions that, when executed by the one or more processors, cause operations comprising:
receiving a user query from a user of a conversational program, wherein the user query requires a first response;
based on the user query, determining a set of model requirements for a first machine learning model, wherein the set of model requirements comprises required input data or activation patterns of the first machine learning model in generating the first response;
based on the set of model requirements, determining first supplemental data corresponding to the required user input and a formatting requirement corresponding to the output patterns, wherein the first supplemental data is necessitated by the user query to generate the first response, and wherein the formatting requirement specifies modifications for the first response to satisfy one or more requirements relating to content or presentation;
performing pre-processing to obtain the first supplemental data from a first supporting software program;
generating a preliminary response using the first machine learning model by processing the user query and the first supplemental data;
performing post-processing of the preliminary response using a second supporting software program, wherein the second supporting software program is designed to modify the preliminary response to adhere to the formatting requirement; and
based on the post-processing of the preliminary response, generating the first response for presentation to the user in the conversational program.

2. A method for dynamically adjusting a machine learning model for producing responses to queries, comprising:
receiving a user query from a user of a conversational program, wherein the user query requires a first response;
based on the user query, determining a set of model requirements for a first machine learning model, wherein the set of model requirements comprises required input data in generating the first response;
based on the set of model requirements, determining first supplemental data corresponding to the required input data and a formatting requirement corresponding to an activation pattern, wherein the first supplemental data is necessitated by the user query to generate the first response;
performing pre-processing to obtain the first supplemental data from a first supporting software program; and
generating the first response using the first machine learning model for presentation to the user in the conversational program by processing the user query and the first supplemental data.

3. The method of claim 2, further comprising:
generating a preliminary response using the first machine learning model by processing the user query and the first supplemental data;
performing post-processing of the preliminary response using a second supporting software program, wherein the second supporting software program is designed to modify the preliminary response to adhere to the formatting requirement; and
based on the post-processing of the preliminary response, generating the first response for presentation to the user in the conversational program.

4. The method of claim 3, wherein the preliminary response comprises textual data with associated metadata, wherein the textual data contains information responsive to the user query, and wherein the associated metadata limits presenting the textual data to the user in the conversational program.

5. The method of claim 4, wherein the post-processing of the preliminary response comprises:
using the second supporting software program, identifying a set of discrepancies based on the formatting requirement and the preliminary response, wherein the set of discrepancies comprises one or more aspects of the preliminary response that fail to meet the formatting requirement;
generating a set of corrections by, for each discrepancy in the set of discrepancies, identifying a correction corresponding to the discrepancy, wherein the set of corrections comprises modifications to the textual data or the associated metadata of the preliminary response; and
applying the set of corrections to the preliminary response to generate the first response.

6. The method of claim 2, wherein determining the set of model requirements comprises:
determining a category of the user query, wherein the category is one of record retrieval, task execution, information update, and idea generation;
based on the category of the user query, determining an activation pattern of the first machine learning model;
based on the category of the user query, the user query, and a history of the conversational program, determining a type of relevant data and a set of external programs; and
generating the set of model requirements to include the activation pattern, the type of relevant data, and the set of external programs.

7. The method of claim 6, wherein the first supplemental data comprises data from the type of relevant data, wherein the set of external programs is used to obtain the first supplemental data.

8. The method of claim 6, wherein determining the first supplemental data comprises:
generating a plurality of candidate datasets using the set of external programs, wherein the plurality of candidate datasets contain data related to the user query;
generating a ranking of the plurality of candidate datasets based on relevance metrics for each candidate dataset in the plurality of candidate datasets, wherein the relevance metrics indicate a likely relatedness from a candidate dataset to the user query; and
based on the ranking of the plurality of candidate datasets, generating the first supplemental data based on one or more of the plurality of candidate datasets.

9. The method of claim 2, wherein determining the formatting requirement comprises:
retrieving a set of compliance requirements and a set of quality requirements, wherein the set of compliance requirements restricts the first response to maintain cybersecurity and confidentiality, and wherein the set of quality requirements restricts the first response for factual accuracy and relevance; and
generating the formatting requirement based on the set of compliance requirements and the set of quality requirements.

10. The method of claim 2, further comprising:
receiving training data comprising past user queries and supplemental data, formatting requirements, and responses corresponding to each past user query; and
training the first machine learning model on the training data, wherein the first machine learning model uses a deep neural network to generate conversational responses to input user queries.

11. The method of claim 2, wherein processing the user query and the first supplemental data comprises:
causing the first machine learning model to process the user query and the first supplemental data as input; and
using recurrent layers, feedforward layers, embedding layers, and attention layers of the first machine learning model, generating an output text sequence corresponding to the first response.

12. The method of claim 2, further comprising:
receiving, in associate with the user query, a user request defining a second response, wherein the user request limits the content or format of the second response;
generating an updated formatting requirement by updating the formatting requirement based on the user request; and
determining second supplemental data based on the user request.

13. The method of claim 12, further comprising:
generating a preliminary response using the first machine learning model by processing the user query and the second supplemental data;
performing post-processing of the preliminary response to modify the preliminary response to adhere to the updated formatting requirement; and
based on the post-processing of the preliminary response, generating the second response for presentation to the user in the conversational program.

14. One or more non-transitory computer-readable media comprising instructions that, when executed by one or more processors, cause operations comprising:
receiving a user query from a user of a conversational program, wherein the user query requires a first response;
based on the user query, determining a set of model requirements for a first machine learning model, wherein the set of model requirements comprises required input data in generating the first response;
based on the set of model requirements, determining first supplemental data corresponding to the required input data and a formatting requirement corresponding to an activation pattern, wherein the first supplemental data is necessitated by the user query to generate the first response;
performing pre-processing to obtain the first supplemental data from a first supporting software program; and
generating the first response using the first machine learning model for presentation to the user in the conversational program by processing the user query and the first supplemental data.

15. The one or more non-transitory computer-readable media of claim 14, wherein the operations further comprise:
generating a preliminary response using the first machine learning model by processing the user query and the first supplemental data;
performing post-processing of the preliminary response using a second supporting software program, wherein the second supporting software program is designed to modify the preliminary response to adhere to the formatting requirement; and
based on the post-processing of the preliminary response, generating the first response for presentation to the user in the conversational program.

16. The one or more non-transitory computer-readable media of claim 15, wherein the preliminary response comprises textual data with associated metadata, wherein the textual data contains information responsive to the user query, and wherein the associated metadata limits presenting the textual data to the user in the conversational program.

17. The one or more non-transitory computer-readable media of claim 16, wherein the post-processing of the preliminary response comprises:
using the second supporting software program, identifying a set of discrepancies based on the formatting requirement and the preliminary response, wherein the set of discrepancies comprises one or more aspects of the preliminary response that fail to meet the formatting requirement;
generating a set of corrections by, for each discrepancy in the set of discrepancies, identifying a correction corresponding to the discrepancy, wherein the set of corrections comprises modifications to the textual data or the associated metadata of the preliminary response; and
applying the set of corrections to the preliminary response to generate the first response.

18. The one or more non-transitory computer-readable media of claim 14, wherein determining the set of model requirements comprises:
determining a category of the user query, wherein the category is one of record retrieval, task execution, information update, and idea generation;
based on the category of the user query, determining an activation pattern of the first machine learning model;
based on the category of the user query, the user query, and a history of the conversational program, determining a type of relevant data and a set of external programs; and
generating the set of model requirements to include the activation pattern, the type of relevant data, and the set of external programs.

19. The one or more non-transitory computer-readable media of claim 18, wherein the first supplemental data comprises data from the type of relevant data, wherein the set of external programs is used to obtain the first supplemental data.

20. The one or more non-transitory computer-readable media of claim 18, wherein determining the first supplemental data comprises:
generating a plurality of candidate datasets using the set of external programs, wherein the plurality of candidate datasets contain data related to the user query;
generating a ranking of the plurality of candidate datasets based on relevance metrics for each candidate dataset in the plurality of candidate datasets, wherein the relevance metrics indicate a likely relatedness from a candidate dataset to the user query; and
based on the ranking of the plurality of candidate datasets, generating the first supplemental data based on one or more of the plurality of candidate datasets.
